(19) United States
(12) Patent Application Publication
(10) Pub. No.: US 2024/0352985 A1
(43) Pub. Date: Oct. 24, 2024

(54) IMPROVISED DISC BRAKE ROTOR

(71) Applicant: Disc Brakes Australia Pty. Limited, Silverwater, New South Wales (AU)

(72) Inventor: Brian JOHNS, Silverwater, New South Wales (AU)

(21) Appl. No.: 18/685,085

(22) PCT Filed: Aug. 18, 2022
(86) PCT No.: PCT/AU2022/050920

§ 371 Date: Feb. 20, 2024

(30) Foreign Application Priority Data
Aug. 19, 2021 (AU) 2021902603

(51) Int. Cl. F16D 65/12; F16D 65/02

(52) U.S. Cl. CPC F16D 65/128; F16D 2065/132; F16D 2065/1328; F16D 2250/0084

(57) ABSTRACT

Disclosed is a disc brake rotor; the rotor including a central hub coaxial with and supporting annular rings which form an inboard brake band and an outboard brake band for engagement with brake pads of a disc brake; the inboard brake band and the outboard brake band maintained in a parallel spaced apart configuration by an array of pillars; the array of pillars arranged in repeating families of individually shaped pillars. Also disclosed is a method of optimising shape of pillars in groups of pillars of a disc brake rotor; the disc brake rotor comprising inner and outer annular brake bands maintained in spaced apart parallel configuration by the groups of pillars; the method including the steps of:—arranging the pillars into repeating families of pillars; each family lying in a 22.5 degree sector of the rotor;—further arranging each family into two groups of pillars; an outer group of pillars and an inner group of pillars;—forming each outer group of pillars and inner group of pillars to comprise of two larger pillars and two smaller pillars, and wherein each larger pillar and each smaller pillar in a family of pillars has a distinctive shape.

### TECHNICAL FIELD

The present invention relates to disc brakes for vehicles and, more particularly to the discs or rotors of such brakes.

### BACKGROUND

Braking systems are of course an essential component of motor vehicles, used to control vehicle speed and to bring a vehicle to rest. For passenger vehicles, in the main, the preferred braking system is that of disc brakes in which clamping brake pads are applied to opposing sides of a disc brake rotor, rotating in unison with a vehicle road wheel. Disc brakes are preferred because they can withstand considerably higher temperatures than the drum brakes which they have largely replaced.

The major cause of brake “fade”, that is, loss of braking efficiency and brake failure in disc brakes, is due to excessive heat building up in the brake disc rotor from friction between the brake pads and the surfaces of the brake disc rotor when the pads are applied to the surfaces under pressure.

Long repetitive braking leads to temperature rise, in particular of the disc rotor, reducing the effectiveness of the braking system, so that proper cooling of the braking system is an important safety issue. It is essential that the rotor must be able to dissipated heat as fast as possible, both to maintain braking efficiency and to prolong the life of the rotor.

To alleviate heat build-up, ventilated brake disc rotors were developed in which the rotor comprises two discs, or brake bands; an inboard disc and an outboard disc maintained in a parallel spaced apart configuration by internal structures between the discs, and between which air could flow. Such an arrangement was disclosed for example in WO02090791 by the present applicant, in which air drawn into the spaces between the inner and outer discs flows between spacing pillars from an inner periphery towards and out of the rotor's periphery.

Nevertheless, excessive heat build-up continues to be a problem when hard or prolonged braking of a vehicle is required.

It is an object of the present invention to address or at least ameliorate some of the above disadvantages.

### Notes

The term “comprising” (and grammatical variations thereof) is used in this specification in the inclusive sense of “having” or “including”, and not in the exclusive sense of “consisting only of”.

The above discussion of the prior art in the Background of the invention, is not an admission that any information discussed therein is citable prior art or part of the common general knowledge of persons skilled in the art in any country.

### SUMMARY OF INVENTION

Accordingly, in a broad form of the invention, there is provided a disc brake rotor; the rotor including a central hub coaxial with and supporting annular rings which form an inboard brake band and an outboard brake band for engagement with brake pads of a disc brake; the inboard brake disc and the outboard brake disc maintained in a parallel spaced apart configuration by an array of pillars; the array of pillars arranged in repeating families of individually shaped pillars.

Preferably, each repeating family lies within a sector of the rotor.

Preferably, each sector is defined by an angle of 22.5 degrees.

Preferably, each family of pillars includes eight pillars divided into two groups of pillars; a first group of four outer pillars lying in an outward half of the sector and a second group of four inner pillars lying within an inward facing half of the sector.

Preferably, the outer group of pillars includes two larger outer pillars; each of the two larger outer pillars being of similar diamond shape.

Preferably, in each larger outer pillar a ration of a first maximum dimension in a radial direction to a maximum transverse dimension is 2.

Preferably, the maximum dimension in a radial direction of the larger outer pillars is approximately 0.5 of a radial distance between an inner and an outer periphery of the brake band.

Preferably, long axes of each of the two larger outer pillars is inclined relative radial lines passing through respective centres of the larger outer pillars.

Preferably, the inclination of the long axes lies between 15 degrees and 20 degrees.

Preferably, the inclination of the long axes is opposite to a direction of rotation of the rotor.

Preferably, the first group of outer pillars further includes two smaller outer pillars; each smaller outer pillar positioned adjacent a clockwise side of each of the two larger outer pillars.

Preferably, each smaller outer pillar has a maximum dimension in a radial direction equal to approximately 0.45 of the maximum dimensions in the radial direction of the two larger outer pillars.

Preferably, each of the two smaller outer pillars are of an approximate diamond shape rounded at each end; the diamond shape modified so as to approach the shape of an asymmetric oval in which an inward facing half of the oval is longer and narrower than an outward facing half.

Preferably, a gap in a clockwise direction between a first of the two larger outer pillars and an adjacent smaller outer pillar is approximately 0.2 of the maximum transverse dimension of the first larger outer pillar.

Preferably, a gap in a clockwise direction between a second of the two larger outer pillars and an adjacent smaller pillar is approximately 0.5 of the maximum transverse dimension of the second larger outer pillar.

Preferably, the four inner pillars of the second group of inner pillars is arranged in a pattern of: larger inner pillar, smaller inner pillar, larger inner pillar, smaller inner pillar; each of the inner pillars having an inward facing end proximate the inner periphery of the rotor.

Preferably, each of the two larger inner pillars is formed based on a generally diamond shape elongated in a generally radial direction.

Preferably, long sides of each of the two larger inner pillars are inclined at approximately 15-20 degrees in a clockwise direction relative radial lines passing through centres of the larger inner pillars.

Preferably, a first of the two larger inner pillars has a concave inset along each of two longer edges.

Preferably, a second of the two larger inner pillars has a convexly projecting longer edge on an anticlockwise longer side and a concave inset on a clockwise longer side.

Preferably, the first group of outer pillars is radially shifted relative the second inner group of pillars.

In another broad form of the invention there is provided a method of optimising shape of pillars in groups of pillars of a disc brake rotor; the disc brake rotor comprising inner and outer annular brake bands maintained in spaced apart parallel configuration by the groups of pillars; the method including the steps of:
arranging the pillars into repeating families of pillars; each family lying in a 22.5 degree sector of the rotor;
further arranging each family into two groups of pillars; an outer group of pillars and an inner group of pillars;
forming each outer group of pillars and inner group of pillars to comprise of two larger pillars and two smaller pillars, and wherein each larger pillar and each smaller pillar in a family of pillars has a distinctive shape.

Preferably, a long axis of each larger outer pillar is inclined relative a radial line passing through a centre of the larger outer pillar.

Preferably, the inclination of the long axes lies between 15 degrees and 20 degrees.

Preferably, the inclination of the long axes is opposite to a direction of rotation of the rotor.

Preferably, the method includes the further provision of smaller pillars lying between each adjacent pair of larger outer pillars and larger inner pillars.

Preferably, distinctive shapes of the pillars is derived from an iterative computational process; the process set to achieve a maximum flow of air from an inner periphery of the rotor to an outer periphery by modification of initial generally diamond pillar shape.

### BRIEF DESCRIPTION OF DRAWINGS

Embodiments of the present invention will now be described with reference to the accompanying drawings wherein:

FIG. 1 is a perspective view of a disc brake rotor according to a preferred embodiment of the invention;

FIG. 2 is a perspective sectioned view of the rotor of FIG. 1; ed

FIG. 3 is a 22.5 degree sector of the sectioned view of FIG. 2;

FIG. 4 is a further view of the sector of FIG. 3 showing an inclination of long axes of larger outer pillars relative to radii passing through their centres.

FIG. 5 is a further view of the sector of FIGS. 3 and 4 showing relative length of outer larger pillars and smaller pillars;

FIG. 6 is a further view of the sector of FIGS. 3 to 5 showing some comparisons of critical dimensions of pillars and gaps between pillars;

FIGS. 7A ad 7B indicate some major flow paths around selected outer larger and inner larger pillars;

FIG. 8 shows another view of the sector of FIGS. 3 to 7A and 7B indicating features of edge orientation and ventilating air passages.

### DESCRIPTION OF EMBODIMENTS

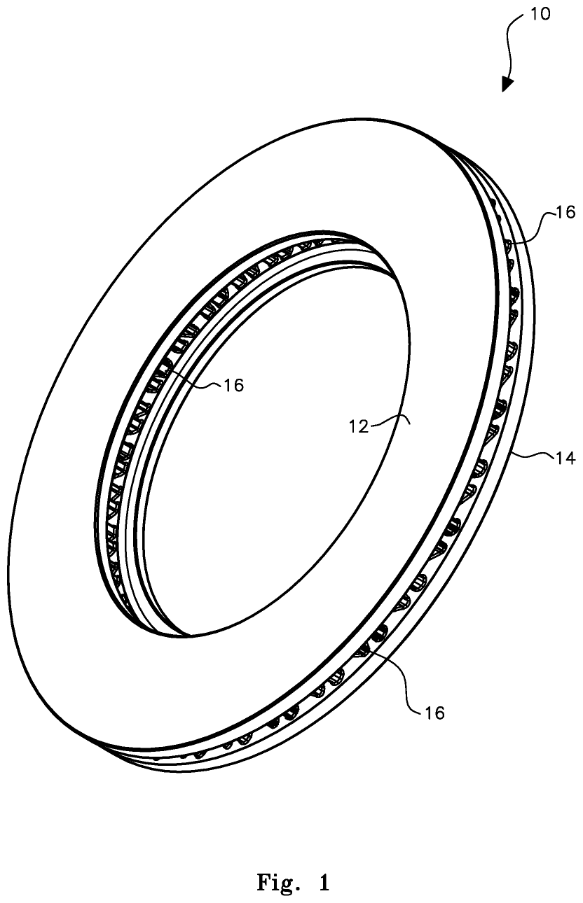

Ventilated disc brake rotors, such as the rotor 10 shown in FIG. 1 are of cast iron with an inner brake band 12 and an outer brake band 14 against which the pads of the calliper brake mechanism (not shown) are forced in a braking situation, held in spaced-apart concentric and parallel condition by integral pillars 16. It is an object in the design of the pillars and their disposition in particular to make the flow of cooling air as efficient as possible. A design is generally achieved by intuitive and empirical means, but it has proved difficult derive an optimal configuration of a required combined density of pillars for strength with flow of air.

The configuration of pillars of the rotor 10 present invention was achieved through an iterative shape optimization computational process in which heat transfer rate from the inner surfaces of the brake bands and the surfaces of the pillars to air, was set as the target, with the objective to maximize that heat transfer in the case given a target temperature of the surfaces for a rotational velocity of the disc, starting from an initial, generally uniform shape and pattern of pillars. The resulting pattern and shape of pillars of the invention has been tested at various values of temperature and velocity of disc rotation, performing better that the performance of the initial seed pattern of pillars,

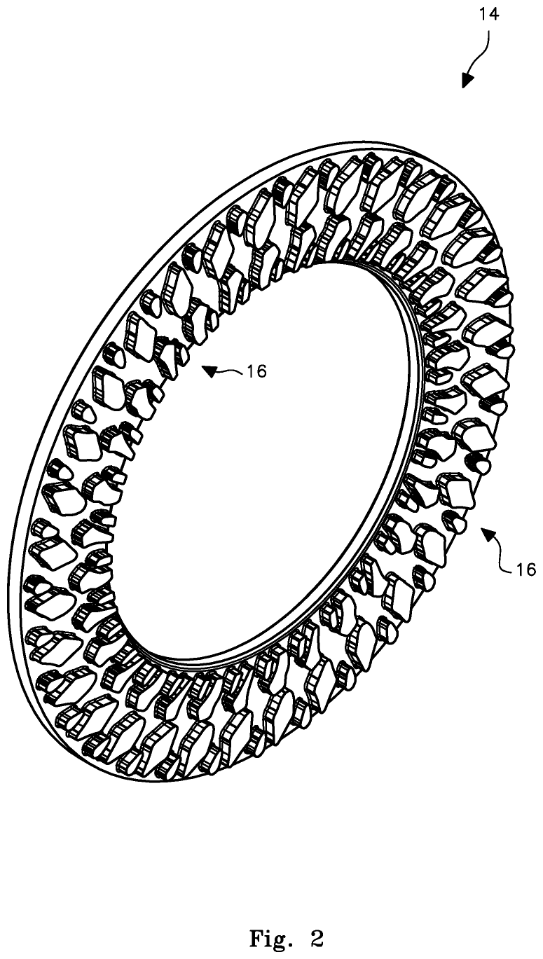

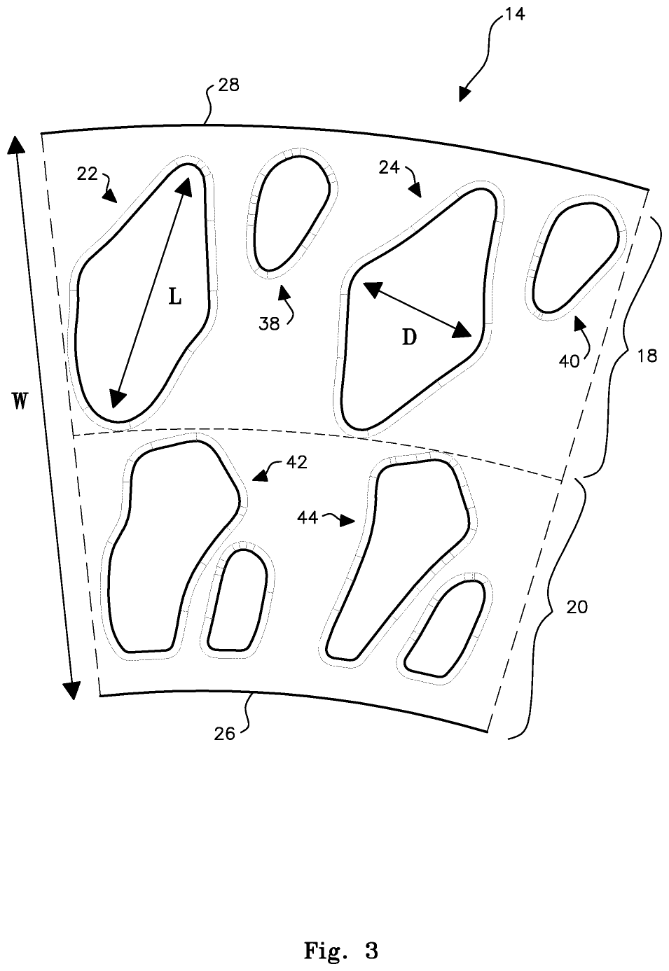

With reference to FIGS. 2 and 2A, in a preferred embodiment of the invention, the pillars which extend between internals surfaces of opposing brake bands of a brake disc rotor, are arranged in repeating patterns or families 16 of eight, individually shaped pillars, lying in 22.5 degree sectors of the rotor 10 as more particularly shown in FIG. 3.

The pillars of each family 16 of pillars, may be divided into two groups; a first group of outer pillars 18 lying in an outward half of the sector, which may be defined (r−Rmin)/(Rmax−Rmin)>0.5, where Rmin and Rmax define the inner and outer peripheries of the rotor respectively, and a second group of inner pillars 20 lying in an inward half of the sector. Each of the pillars within the two groups are close to, or based on, an underlying geometry of a diamond shape.

With reference again to FIG. 3 two of the pillars, first larger outer pillar 22 and second larger outer pillar 24 of the four pillars of the group of outer pillars are of similar diamond form with each having a ratio of a maximum dimension L in a radial direction to that of D in a transverse direction, approximately equal to 2. The maximum dimension L of the larger diamond-shaped pillars of the two similar larger outer pillars 22 and 24 is approximately equal to 0.5 of the radial distance W between the inner periphery 26 and outer periphery 28 of the rotor.

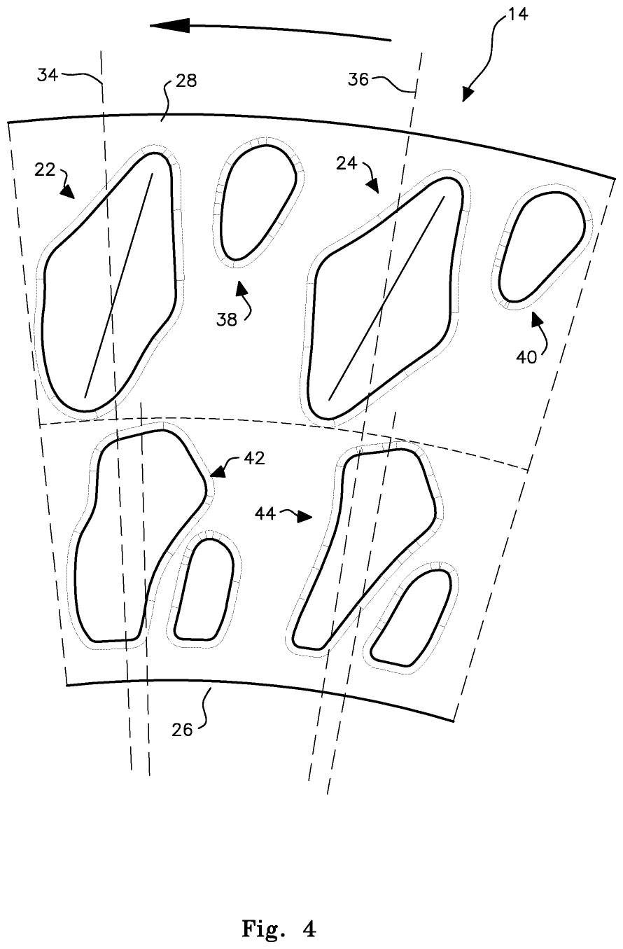

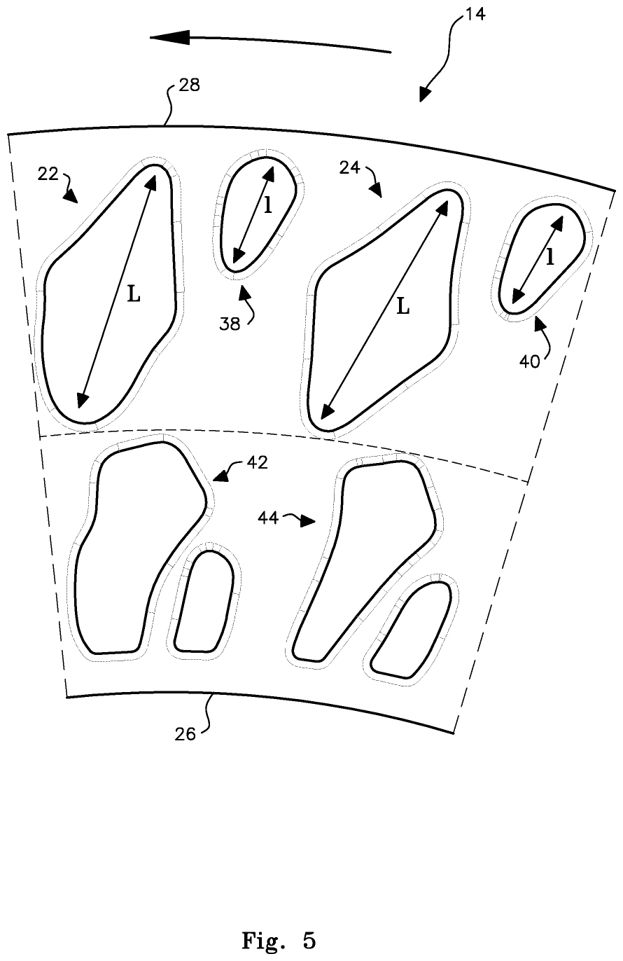

With reference now to FIG. 4, the long axes 30 and 32 respectively of each of the two diamond-shaped pillars 22 and 24, lie at an angle in a range of 15 to 20 degrees, preferably 20 degrees to radial lines 34 and 36 of the rotor passing through the centres of the pillars. When the rotor 10 is rotating in an anticlockwise direction (as viewed in FIG. 4) the inclination of the long axes of the pillars in the clockwise direction provides for flow of ventilating air parallel to the edges of the pillars without changing the momentum of the flow, thus minimizing the flow deflection from its main direction. This arrangement provides form optimal rates of heat transfer from the rotor.

[point 7-8] Additionally, referring to FIG. 5, there are two smaller outer pillars 38 and 40 in the group of outer pillars, which have a radial length l of 0.45 that of the dimension L of the larger diamond-shaped pillars 22 and 24. Each of these two smaller pillars is positioned adjacent the clockwise side of each of the two diamond-shaped pillars and proximate the outer periphery 28 of the rotor.

In form, these two small outer pillars are of modified diamond, approaching that of an asymmetric oval, being rounded at both their inner and outer ends, with the inward facing half being longer in length and narrower than the outward facing half.

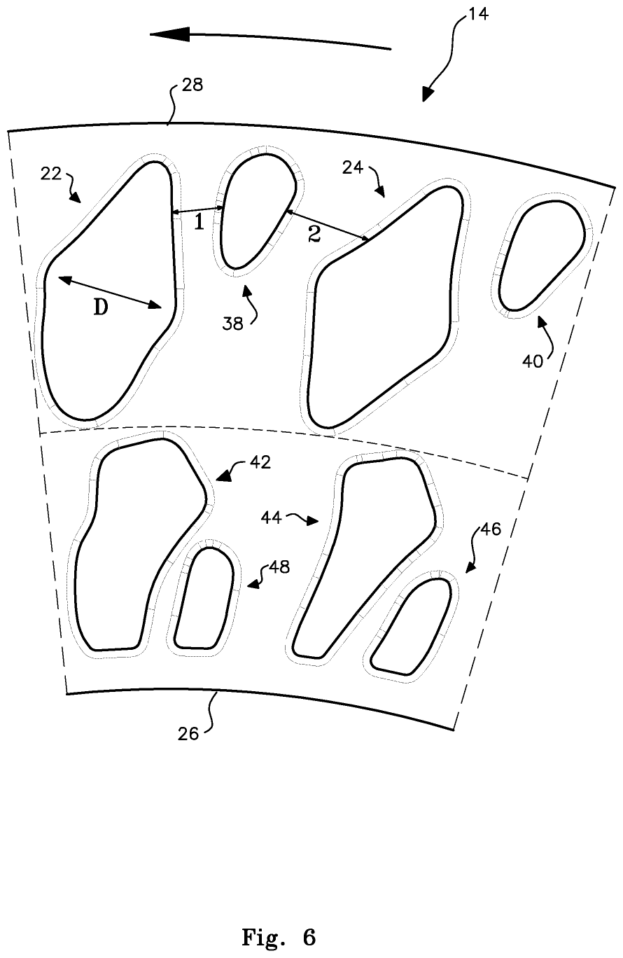

As shown in FIG. 6, the gap 1 between the small outer pillar 38 and the adjacent larger diamond-shaped pillar 22 lying in an anticlockwise direction to it, equals 0.3 of the transverse dimension D of the larger pillar, while the gap 2 between it and the adjacent larger diamond-shaped pillar in the clockwise direction is 0.5D.

These small distances between each small outer pillar and the adjacent larger diamond-shaped pillar assist to direct the flow of air that is being detached from the corners of the larger pillars, to maintain a sufficient flow rate between the smaller and larger pillars, thus again increasing the rate of heat transfer from the rotor.

Turning again to FIG. 3, the four inner pillars of the group of inner pillars 20, all positioned in the inward half of the sector (r−Rmin)/(Rmax−Rmin)<0.5, also follow a “large pillar, small pillar, large pillar, small pillar” pattern in a clockwise direction. All pillars of this inner group have their inward ends proximate the inner periphery 26 of the rotor. The shape of the inner pillars was developed to maximise the surface areas of the pillars exposed to the flow of air with minimal drag, allowing air to flow past them with minimum resistance at as high a velocity as possible, thus again maximising heat transfer. This is achieved by narrow gaps and elongated pillar shapes.

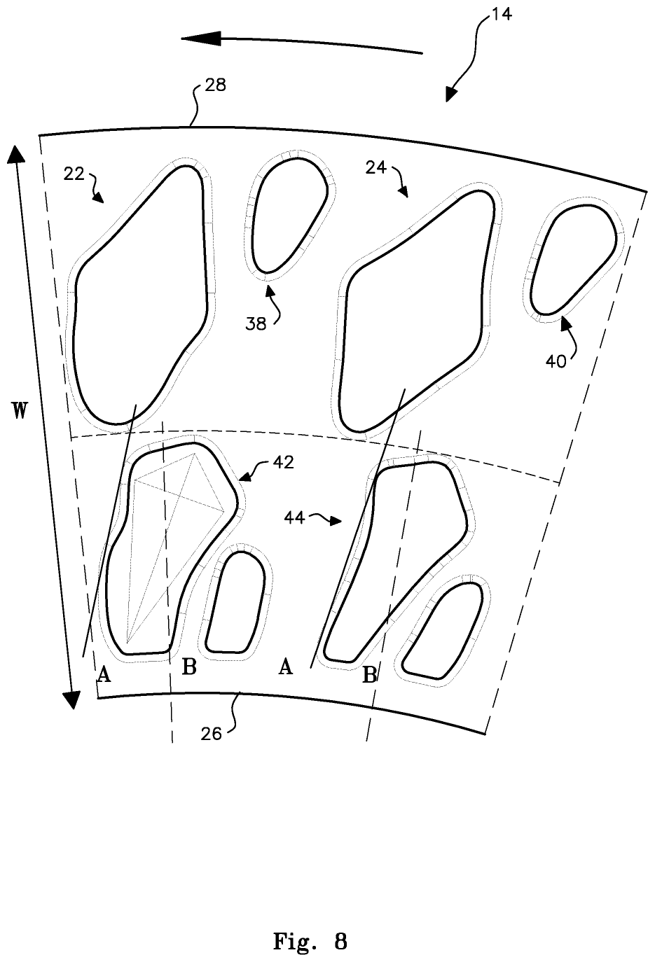

The forms of the larger inner pillars 42 and 44 are again based on a diamond-like shape, elongated in a generally radial direction, each having a long side 46 and 48 respectively and generally in the radial direction but with a 15-20 degree inclination in the clockwise direction as shown in FIG. 8. The longer inward facing end of the diamond-like shape is five times that of the outward facing end. The aerodynamic shape allows direction of the flow of ventilating air along narrow passages between the pillars while retaining high velocities.

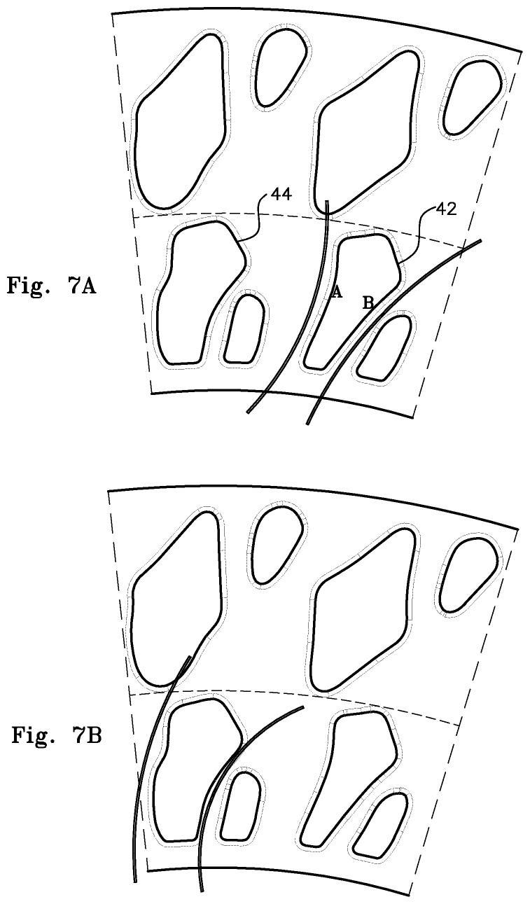

With reference now to FIGS. 7A and 7B, a first pillar 42 of the two larger inner pillars, has a concave inset along each of its two longer edges, while the second pillar 44 is provided with convexly projecting longer edge on its anticlockwise longer side and a concave inset on it clockwise longer side. The convexly projecting longer edge is further modified by an indentation in its middle. The combined shapes of these larger of the inner pillars direct the bulk of cooling air to flow smoothly parallel to the anticlockwise side A of the first lager inner pillar, with the remainder of the flow being directed along the clockwise side B, where it enters a narrow passage parallel to smaller inner pillars interposed between the larger pillars.

As indicated by the pattern A, B, A, B in FIG. 8, each pair of a larger inner pillar 42 and 44 and smaller inner pillar 46 and 48 create a narrow channel between their adjacent edges which accelerates the flow of air and heat dissipation, in similar fashion to the pairing of outer pillars. The two smaller inner pillars are shaped approximately as elongated rectangles with long sides parallel to the air flow passages and an inner short side parallel to and adjacent the inner periphery of the rotor. The outermost short side of these smaller pillars is smoothed into an arcuate shape and is a feature which allows the flow of air to exit the narrow passages without excessive deceleration and deflection.

The length of the smaller inner pillars is 0.45 that of the length of the larger inner pillars; that is the same ratio as that of the smaller outer and larger outer pillars of the first outer group of pillars. The width of the smaller inner pillars lies preferably between 2.2-2.7 times of their length.

As can be seen from FIG. 8, the outer ends of the larger inner pillars and the inner ends of the larger outer pillars, lie on the circle 50 defining the middle of the width of the brake band, so that there is no distance, in the radial direction, between the larger outer and the larger inner pillars. As can also be seen in each of the figures of the sector of the rotor and is best seen in FIG. 4, the group of outer pillars is radially shifted in the anticlockwise direction by approximately 10 degrees relative the group inner pillars. This arrangement provides for the flow of air being streamlined along the anticlockwise sides of the larger inner pillars, and then along the clockwise side of the larger outer pillars.

### INDUSTRIAL APPLICABILITY

The unique pattern of pillars of the ventilated disc brake rotor of the invention, established through iterations of finite element analysis and adjustments of input parameters, has achieved an optimum balance between strength of the pillars to withstand the forces applied to the brake bands, and efficient flow of air from the inner periphery of the rotor to its outer periphery, leading to improved heat dissipation.

1. A disc brake rotor; the rotor comprising a central hub coaxial with and supporting annular rings which form an inboard brake band and an outboard brake band for engagement with brake pads of a disc brake; the inboard brake band and the outboard brake band maintained in a parallel spaced apart configuration by an array of pillars; the array of pillars arranged in repeating families of individually shaped pillars.

2. The rotor of claim 1 wherein each repeating family lies within a sector of the rotor.

3. The rotor of claim 2 wherein each sector is defined by an angle of 22.5 degrees.

4. The rotor of claim 1 wherein each family of pillars includes eight pillars divided into two groups of pillars; a first group of four outer pillars lying in an outward half of the sector and a second group of four inner pillars lying within an inward facing half of the sector.

5. The rotor of claim 4 wherein the first group of pillars includes two larger outer pillars; each of the two larger outer pillars being of similar diamond shape.

6. The rotor of claim 5 wherein in each larger outer pillar a ration of a first maximum dimension in a radial direction to a maximum transverse dimension is 2.

7. The rotor of claim 4 wherein the maximum transverse dimension in a radial direction of the larger outer pillars is approximately 0.5 of a radial distance between an inner and an outer periphery of the brake band.

8. The rotor of claim 5 wherein long axes of each of the two larger outer pillars is inclined relative radial lines passing through respective centers of the larger outer pillars.

9. The rotor of claim 8 wherein the inclination of the long axes lies between 15 degrees and 20 degrees.

10. The rotor of claim 8 wherein the inclination of the long axes is opposite to a direction of rotation of the rotor.

11. The rotor of claim 4 wherein the first group of outer pillars further includes two smaller outer pillars; each smaller outer pillar positioned adjacent a clockwise side of each of the two larger outer pillars.

12. The rotor of claim 11 wherein each smaller outer pillar has a maximum dimension in a radial direction equal to approximately 0.45 of the maximum dimensions in the radial direction of the two larger outer pillars.

13. The rotor of claim 11 wherein each of the two smaller outer pillars are of an approximate diamond shape rounded at each end; the diamond shape modified so as to approach the shape of an asymmetric oval in which an inward facing half of the oval is longer and narrower than an outward facing half.

14. The rotor of claim 11 wherein a gap in a clockwise direction between a first of the two larger outer pillars and an adjacent smaller outer pillar is approximately 0.2 of the maximum transverse dimension of the first larger outer pillar.

15. The rotor of claim 11 wherein a gap in a clockwise direction between a second of the two larger outer pillars and an adjacent smaller pillar is approximately 0.5 of the maximum transverse dimension of the second larger outer pillar.

16. The rotor of claim 4 wherein the four inner pillars of the second group of inner pillars is arranged in a pattern of: larger inner pillar, smaller inner pillar, larger inner pillar, smaller inner pillar; each of the inner pillars having an inward facing end proximate the inner periphery of the rotor.

17. The rotor of claim 16 wherein each of the two larger inner pillars is formed based on a generally diamond shape elongated in a generally radial direction.

18. The rotor of claim 16 wherein long sides of each of the two larger inner pillars are inclined at approximately 15-20 degrees in a clockwise direction relative radial lines passing through centres of the larger inner pillars.

19. The rotor of claim 16 wherein a first of the two larger inner pillars has a concave inset along each of two longer edges.

20. The rotor of claim 16 wherein a second of the two larger inner pillars has a convexly projecting longer edge on an anticlockwise longer side and a concave inset on a clockwise longer side.

21. The rotor of claim 4 wherein the first group of outer pillars is radially shifted relative the second group of inner pillars.

22. A method of optimizing shape of pillars in groups of pillars of a disc brake rotor; the disc brake rotor comprising inner and outer annular brake bands maintained in spaced apart parallel configuration by the groups of pillars; the method including the steps of:
arranging the pillars into repeating families of pillars; each family lying in a 22.5 degree sector of the rotor;
further arranging each family into two groups of pillars; an outer group of pillars and an inner group of pillars;
forming each outer group of pillars and inner group of pillars to comprise of two larger pillars and two smaller pillars, and
wherein each larger pillar and each smaller pillar in a family of pillars has a distinctive shape.

23-27. (canceled)
